(19) United States
(12) Patent Application Publication
(10) Pub. No.: US 2008/0133385 A1
(43) Pub. Date: Jun. 5, 2008

(54) Internet clearinghouse for homeowner association information

(75) Inventor: Charles E. Lanter, Fort Collins, CO (US)

Correspondence Address: CR MILES, P.C.;CRAIG R. MILES, 405 MASON COURT, SUITE 119, FORT COLLINS, CO, 80524, US

(73) Assignee: Lanter & Associates, LLC

(21) Appl. No.: 11/633,699

(22) Filed: Dec. 4, 2006

(51) Int. Cl. G06Q 30/00; G06Q 90/00

(52) U.S. Cl. 705/30; 705/1

(57) ABSTRACT

Generally, a computer-implemented portal through which a plurality of user computers access homeowner association data over the internet. Specifically, a homeowner association database which allows access to homeowner association data by a plurality of remote computer users through a graphic user interface which allows activation of a plurality of homeowner association participant modules each matched to a portion of the homeowner association data stored in the homeowner association database relevant to the homeowner association participant.

### I. BACKGROUND

Generally, a computer-implemented portal through which a plurality of user computers access homeowner association data over the internet. Specifically, a homeowner association database which allows access to homeowner association data by a plurality of remote computer users through a graphic user interface which allows activation of a plurality of homeowner association participant modules each matched to a portion of the homeowner association data stored in the homeowner association database relevant to the homeowner association participant.

The fastest growing form of housing in the United States today may be the common-interest developments, a category that includes planned-unit developments of single-family homes, condominiums, and cooperative apartments. Before the first unit is sold in one of these developments, the developer records restrictive covenants on each one of the properties. These restrictive covenants “run with the land”, meaning that all successive buyers are bound by the same covenants as the original purchaser. These covenants, among other agreements, form the basis for the homeowners association (or “HOA”).

In recent decades, homeowners associations have become increasingly common in the United States, exercising control over 22.1 million American homes and over 50 million Americans in 2005, according to the Community Associations Institute. Homeowners associations can collect fees, fines, and other assessments from homeowners, maintain the common areas of the development, and enforce the association's governing documents. These may include detailed covenants, regulations or rules regarding construction and maintenance of individual homes. The common areas maintained and governed may include landscaping, common buildings (for example, a clubhouses) and recreational facilities (for example, swimming pools) common walls in attached housing developments, and infrastructure such as streets, mailboxes, sidewalks, and parking lots.

The vast majority of homeowners associations are corporations and are therefore governed by a board of directors (although homeowner associations can take the form of other business entities such as limited liability companies governed by mangers) subject to the bylaws (or other operating agreement) of the corporation. As with any corporation or business entity the governing body conducts board meetings (manager meetings), shareholder meetings (member meetings), and annual meetings in accordance with the bylaws or other operating agreement of the homeowners association. These meetings allow a forum in which the operating agreement of the homeowners association can be amended and and promulgation and amendment of covenants, policies, rules, and regulations of the homeowners association with the participation of the governed body (owners of property subject to the homeowners association). The governing body of the homeowners association also has the authority to control the finances, prepare financial statements, prepare tax returns, enter into contracts to obtain insurance, vendor services, conduct studies, or the like.

The primary goal of a homeowners association is the preservation of property value. The homeowners association preserves property value primarily by enforcing the covenants of the homeowners association. Enforcement of the covenants of the homeowners association establishes a consistent set of standards for all the properties governed by a particular homeowners association. As an example, this prevents one home on a property governed by a particular homeowners association from being painted pink while all the other homes on properties governed by the same homeowners association are painted brown.

The successful operation of any particular one homeowners association depends upon participation by numerous persons in various discrete roles. For example, a particular homeowners association will at least include a homeowners association governing body typically taking the form of a board of directors (although use of this term generically refers to members of the governing body of the homeowners association) as above discussed and a homeowners association governed body taking the form of homeowners association members (although use of this term also refers to properties contractually bound by covenants of the homeowners association). Because each successive buyer of a property within a homeowners association is bound by the same covenants as the original purchaser of the property in the homeowners association; realtors, appraisers, lenders must each participate in their discrete roles with the homeowners association. As such, a significant problem in the operation of any particular homeowners association can be access and retrieval of a portion of the homeowner association information corresponding to each discrete role whether a member of the board of directors, a homeowners association member, a realtor, an appraiser, a lender, an agent for a title company, a vendor, or the like.

Another significant problem faced by homeowners associations and the participants in the homeowners association can be the lack of consistent schema to carry out the activities of each participant's discrete role. Typically, each homeowners association independently develops and implements schema to carry out the activities associated with its operation such as providing the correct subset of information to participants in each discrete role, enforcing covenants, collecting fees, dues or assessments, filing and releasing liens, preparing status letters, or the like. As such, between the numerous homeowners associations, even in the same general region, there can be a great variation in the manner in which homeowners associations carry out activities with the each of the various participants in their roles relating to the homeowners association.

Another significant problem faced by participants in homeowners associations can be that there is no common homeowners association database, common portal, or common interface through which participants can access and retrieve information relevant to their discrete role relating to one or more of the numerous homeowner associations in a given region. As such, each participant must access and retrieve information independently from each homeowners association based upon the independently developed and implemented schema of each individual homeowners association.

### II. SUMMARY OF THE INVENTION

Accordingly, a broad object of the invention can be to provide a computer-implemented homeowners association software application having an architecture which allows a plurality of participants have different roles to access and retrieve a portion of the homeowner association data of a plurality of homeowners associations relevant to the participants role by access to a single centralized database over a wide area network such as the Internet.

A second broad object of the invention can be to provide a computer-implemented software application which provides schema to utilize the homeowners association data to carry out certain activities associated with the participants role, such as covenant enforcement, lien filing, preparation of status letters, or preparation of other fillable forms.

A third broad object of the invention can be to provide a homeowners association graphic user interface usable by a plurality of participants as computer users at one of a plurality of remote computers to access and retrieve a portion of homeowner association data for one of a plurality of homeowner associations based on the participant's role with the homeowners association.

A fourth broad object of the invention can be to provide a graphic user interface for each of the discrete roles of participants of the homeowners association, such as a member of homeowners association board of directors, a homeowners association member (homeowner or property owner), a realtor which participates in the purchase of sale of a property governed by the homeowners association, an appraiser which participates in appraising a property governed by the homeowners association, a lender which participates in financing the purchase of a property governed by the homeowners association, a title company which participates in the conveyance of a property governed by the homeowners association.

Naturally, further objects of the invention are disclosed throughout other areas of the specification, drawings, photographs, and claims.

### III. A BRIEF DESCRIPTION OF THE DRAWINGS

FIG. 1 shows a block diagram of hardware means and network means of a server computer and a plurality of user computers in accordance with an embodiment of the invention.

FIG. 2 shows a block diagram of a particular embodiment of a part of a homeowners association graphic user interface.

FIG. 3 shows a block diagram of a particular embodiment of a part of the homeowners association graphic user interface utilized by the governing body of a homeowners association.

FIG. 4 shows a block diagram of a particular embodiment of a part of the homeowners association graphic user interface which includes a schema for the enforcement of covenants.

FIG. 5 shows a block diagram of a particular embodiment of a part of the homeowners association graphic user interface which includes a schema for filing and releasing liens.

FIG. 6 shows a block diagram of a particular embodiment of a part of the homeowners association graphic user interface utilized by homeowner association property owners.

FIG. 7 shows a block diagram of a particular embodiment of a part of the homeowners association graphic user interface utilized by realtors.

FIG. 8 shows a block diagram of a particular embodiment of a part of the homeowners association graphic user interface utilized by lenders.

FIG. 9 shows a block diagram of a particular embodiment of a part of the homeowners association graphic user interface utilized by appraisers.

FIG. 10 shows a block diagram of a particular embodiment of a part of the homeowners association graphic user interface utilized by title companies and homeowner association managers to prepare status letters.

FIG. 11 shows a block diagram of a particular embodiment of a part of the homeowners association graphic user interface which provides a schema for accessing information regarding vendors.

FIG. 12 shows a block diagram of a particular embodiment of a part of the homeowners association graphic user interface which provides a schema for accessing a homeowners association directory.

### IV. DETAILED DESCRIPTION OF THE PREFERRED EMBODIMENTS

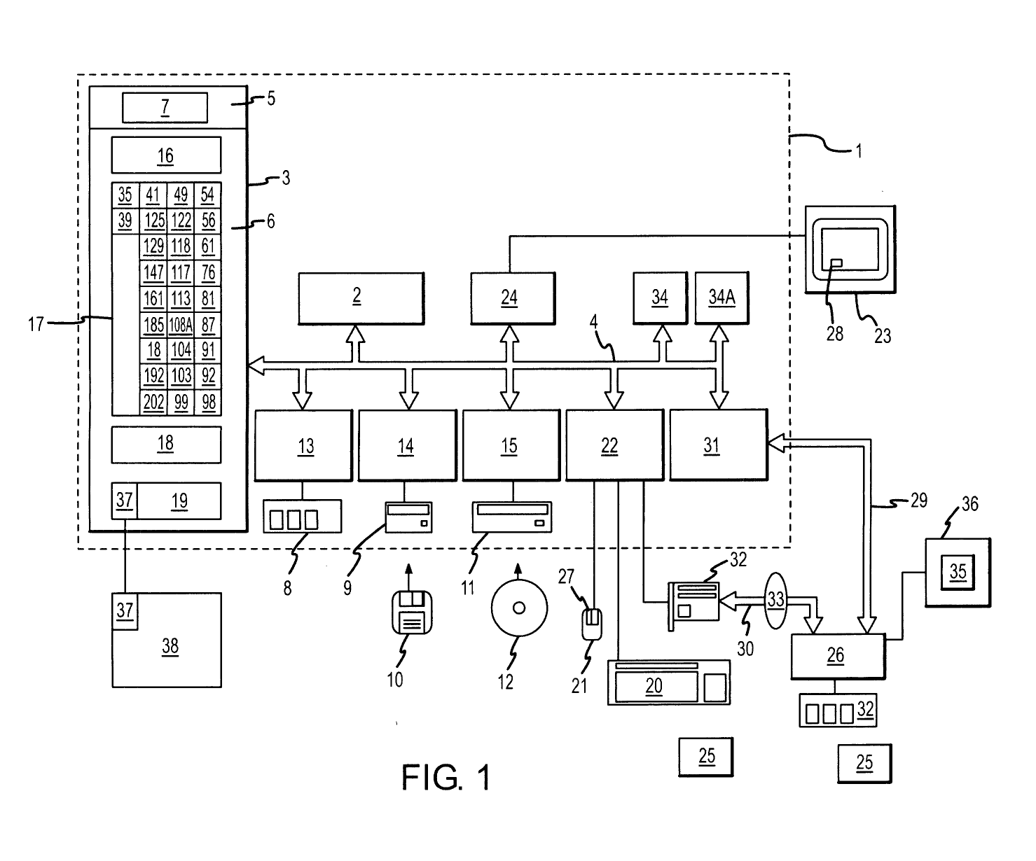

Now referring primarily to FIG. 1 a block diagram of computer means and network means which can be utilized with various embodiments of the invention is shown. While particular computer means and network means to make and use particular embodiments of the invention are described, including the best mode of the invention, it is not intended that the description of any particular embodiment of the computer means or the network means be limiting with respect to the wide variety of similar or equivalent computer means or network means by which the invention can be practiced including without limitation hand-held devices, such as personal digital assistants or camera/cell phone, multiprocessor systems, microprocessor-based or programmable consumer electronics, network PCs, minicomputers, mainframe computers, or the like.

Similarly, it is not intended that embodiments of the invention be practiced in only local computing environments but rather the invention can be practiced in local computing environments or in distributed computing environments where functions or tasks are performed by remote processing devices that are linked through a communications network. In a distributed computing environment, program modules may be located in both local and remote memory storage devices or elements. Also while particular embodiments of the invention are described in the general context of computer-executable instructions such as program modules which utilize routines, programs, objects, components, data structures, or the like, to perform particular functions or tasks or implement particular abstract data types, or the like, being executed by the computer means or the network means, it is not intended that the invention be limited to a particular set of computer-executable instructions or protocols to perform any particular function or task or implement a particular abstract data type.

Again referring to FIG. 1, the invention can include a server computer (1) having at least one processing unit (2), a memory element (3), and a bus (4) which operably couples components of the server computer (I), including without limitation the memory element (3) to the processing unit (2). The server computer (1) may be a conventional computer, a distributed computer, or any other type of computer; the invention is not so limited. The processing unit (2) can comprise one central-processing unit (CPU), or a plurality of processing units which operate in parallel to process digital information. The bus (4) may be any of several types of bus configurations including a memory bus or memory controller, a peripheral bus, and a local bus using any of a variety of bus architectures. The memory element (3) can without limitation be a read only memory (ROM) (5) or a random access memory (RAM) (6), or both. A basic input/output system (BIOS) (7), containing routines that assist transfer of data between the components of the server computer (1), such as during start-up, can be stored in ROM (5). The server computer (1) can further include a hard disk drive (8) for reading from and writing to a hard disk (not shown) a magnetic disk drive (9) for reading from or writing to a removable magnetic disk (10), and an optical disk drive (11) for reading from or writing to a removable optical disk (12) such as a CD ROM or other optical media.

The hard disk drive (8), magnetic disk drive (9), and optical disk drive (11) are connected to the bus (4) by a hard disk drive interface (13), a magnetic disk drive interface (14), and an optical disk drive interface (15), respectively. The drives and their associated computer-readable media provide nonvolatile storage of computer-readable instructions, data structures, program modules and other data for the server computer (1). It can be appreciated by those skilled in the art that any type of computer-readable media that can store data that is accessible by a computer, such as magnetic cassettes, flash memory cards, digital video disks, Bernoulli cartridges, random access memories (RAMs), read only memories (ROMs), or the like, may be used in various embodiments of the computer operating environment.

A number of program modules may be stored on the hard disk, magnetic disk (10), optical disk (12), ROM (5), or RAM (6), including an operating system (16), a homeowners association software application (hereinafter the “HOA application”) (17), other program modules (18), and program data (19) including the homeowners association data (37). A computer user (25) may enter commands and information into the server computer (1) through input devices such as a keyboard (20) and pointing device such as a mouse (21). Other input devices (not shown) may include a microphone, joystick, game pad, satellite dish, scanner, or the like. These and other input devices can be connected to the processing unit (2) through a serial port interface (22) coupled to the bus (4), but may be connected by other interfaces, such as a parallel port, game port, universal serial bus (USB), or the like. A monitor (23) or other type of display device can also be connected to the bus (4) via an interface, such as a video adapter (24), or the like. In addition to the monitor (23), the server computer (1) can further include other peripheral output devices (not shown), such as speakers and printers.

A “click event” occurs when a computer user (25) interfaced with the server computer (I) or any one of a plurality of remote computers (26) (also referred to as a plurality of user computers) operates an application function through the use of a command which for example can include pressing or releasing the left mouse button (27) while a pointer is located over a control icon (28)(also referred to as interface icons) viewable on the monitor (23). However, it is not intended that a “click event” be limited to the press and release of the left button (27) on a mouse (21) while a pointer is located over a control icon (28), rather, the term “click event” is intended to broadly encompass a command by the computer user (25) by which the HOA application (17)(or any program, module, schema, or element thereof) can be applied, independently or in conjunction with other program modules (18) (or elements thereof), to the program data (19) including, but not limited to, the HOA data (37) to activate or to perform a schema, function, or task and can include for example selection of one or a plurality of control icon(s) (28) (whether in serial or in parallel), computer user voice command, keyboard (20) stroke, mouse button (27) stroke, or otherwise. It is further intended that control icons (28), if any, can be configured without limitation as, a point, an area, a circle, a triangle, a square, or other bounded area, or as an information field which can contain addresses such as a street address, zip code, county code, or natural area code, or be used for inputting a latitude/longitude or projected coordinate X and Y, or other notation, script or character, or the like. When the term “click event” is utilized without a specific description to a particular type of computer user interface element or control icon, it is to be understood that a computer user interface element or control icon is included in the invention which corresponds to the click event and activation and operation of the particular function of the HOA application (17) or other program module (18) thereafter described. Similarly, the function activated by a “click event” associated with a graphic user interface icon or control icon having a described exemplary identifier is not intended to limit the invention to that specific identifier and further includes other similar identifiers or identification sufficient to associate the click event with a particular function or module of the HOA application (17) or other program (19) or retrievable data (19).

The server computer (1) may operate in a networked environment using logical connections (29) or (30) to one or a plurality of remote computers (26). These logical connections (29)(30) are achieved by a communication device (31) coupled to or a part of the server computer (1); however, the invention is not limited to any particular type of communications device (31). The remote computer (26) may be another computer, a server, a router, a network PC, a client, a peer device or other common network node, and can include a part or all of the elements above-described relative to the server computer (1), although only a memory storage device (32) has been illustrated. The logical connections (29) (30) depicted in FIG. 1 can provide a local-area network (LAN) logical connections (29) or a wide-area network (WAN) logical connections (30). Such networking environments are commonplace in offices, enterprise-wide computer networks, intranets and the Internet (33).

When used in a LAN environment, the server computer (1) can be connected to the local network through a network interface or adapter (31), which is one type of communications device. When used in a WAN environment, the server computer (1) typically includes a modem (32), another type of communications device, or any other type of communications device which can establish communications over the wide area network (33), such as the Internet. The modem (32), which may be internal or external, is connected to the bus (4) via the serial port interface (22). In a networked environment, the HOA application (17) or program modules (18) depicted relative to the server computer (1), or portions thereof, may be stored in the memory storage device (32) of any one or all of the plurality of remote computers (26). It can be appreciated that the network connections shown are exemplary and other means of and communications devices for establishing a communications link between the server computer (I) and any of the plurality of remote computers (26) (or alternately referred to as user computers) can be used. In certain embodiments of the invention, the server computer (1) allows access by a plurality of remote computers (26) over the WAN to a web server (34) by accepting hypertext transfer protocol (HTTP) requests and serves HTTP responses along with data content in the form of web pages which in part provide a homeowners association application graphic user interface (35)(also referred to as the “HOA graphic user interface”) which can displayed by each of a plurality remote computer monitors (36).

The HOA graphic user interface (35)(also alternately referred to as a graphic user interface) as described more fully below allows a one or a plurality of computer user(s) (25) to activate by click event one or more software programs, applications, modules, or portions thereof of, including without limitation, the HOA application (17) or modules thereof to access, retrieve, and manipulate all or a portion(s) of the homeowners association data (“HOA data”) (37) stored in one or a plurality of memory elements (3) of the server computer (1) or one or more of the plurality of remote computers (26), The HOA data (37) stored in the memory elements (3) of the server computer (1) can include all or a portion of the digitized information of a plurality of homeowners associations (38) without limitation as to boundary or number. As such the plurality of homeowners associations can be located worldwide, in a country, state, county, city or other geopolitical, geographic region, or other bounded area by boundary definition applied. The digitized information can be any digitized information relevant to the operation of or interaction with a homeowners association. For example, without limitation to the forgoing, digitized hard copy documents, electronic documents or files, lists which can contain links to digitized hard copy documents, electronic documents, Internet sites, or the like.

The HOA graphic user interface (35) as described more fully below can also be utilized to activate by click event one or more software applications, modules, or portions thereof of the homeowners association application (17) which function to provide schema along with digital tools, documents, or other digital elements by which the computer user (25) can perform activities associated or interactive with one or each of the plurality of homeowners associations for which HOA data (37) has been stored in the memory element (3) of the server computer (1) (which without limitation includes the various types of memory elements above-discussed whether local or distributed). The server computer (I) can further include an e-mail server (34A) to allow electronic mailing of e-mail. While a particular embodiment of the HOA application (17) and the HOA graphic user interface (35) are described below, it is not intended that the inventive HOA application (17) and the HOA graphic user interface (35) be limited by any single exemplary hierarchical architecture of the various modules or elements which make up the HOA application (17), rather it should be understood that the various functionalities of the HOA application (17) can operate independently or in numerous and varied permutations and combinations and that the particular embodiment of the HOA graphic user interface (35) described is not intended to be limiting with respect to the numerous and varied embodiments of the HOA graphic user interface which are encompassed by the HOA application to allow activation of it numerous and varied functionalites by a computer user (25). Additionally, while particular terms are used to as identifiers to describe each of a plurality of HOA graphic user interface control icons generated by the HOA application (17), such terms are provided as examples and as to particular embodiments of the invention the terms used to identify HOA graphic user interface control icons can be interchanged with different, similar, or equivalent identifiers without altering the function of the program, module, or element of the HOA application (17) activated by click event.

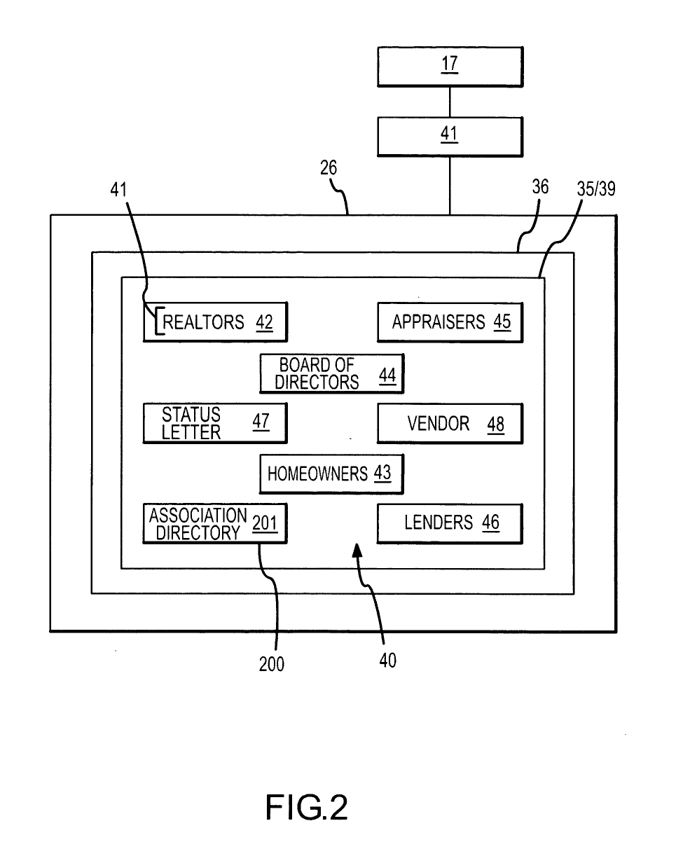

Now referring primarily to FIGS. 1 and 2, the HOA application (17) can include a computer user role identification access module (41) which operates to allocate the HOA data (37) stored in the memory element (3) of the server computer (1) based on the role the computer user (25) performs in relation to one or the plurality of homeowner associations (38). By click event, a computer user (25) at one of the plurality of remote computers (26) can activate the HOA application (17) which delivers to the requesting one of the plurality of remote computers (26) a HOA graphic user interface (35) which in part includes a computer user role identification interface (39) which displays a plurality of computer user role identification control icons (40). Each of the plurality of computer user role identification control icons (40) provides a viewable role indicia (41) which identifies one of the plurality of roles a computer user (25) may perform in relation to one or more of the plurality of homeowner associations (38).

For example, as shown primarily in FIGS. 1 and 2, an embodiment of the computer user role identification interface (39) includes a plurality of computer user role identification control icons (40) with viewable role indicia (41): Homeowner (43), Board of Directors (44), Realtor (42), Appraiser (45), Lender (46), Status Letter (47)(used by computer users of a title company and managers of homeowner associations), and Vendor (48). Each of the plurality of computer user role identification control icons (40) upon click event activates the computer user role identification access module (41) of the HOA application (17) which allows the computer user (25) access to a portion of the HOA data (37) matched to the clicked one of the plurality of user identification control icons (40). In this manner, a computer user (25) which participates with one or more of the plurality of homeowners associations (38) in the capacity of a Realtor, for example, can retrieve by click event of the Realtor user identification control icon (42) the relevant portion of the HOA data (37) stored in the memory element (3) of the server computer (1) in an architecture or schema useful for performing the activities of a Realtor in relation to a particular one of the plurality of homeowner associations (38).

Understandably, the computer user role identification interface (39) above-described is not intended to limit the HOA application (17) to displaying this particular graphic design or number of computer user roles identified and a lesser or greater number of computer user role identification icons (40) can be included in the computer user role identification interface (39) so long as the computer user role identification interface (39) functions to allow access to HOA data (37) matched to the role the computer user (25) performs in relation to the plurality of homeowners associations (38).

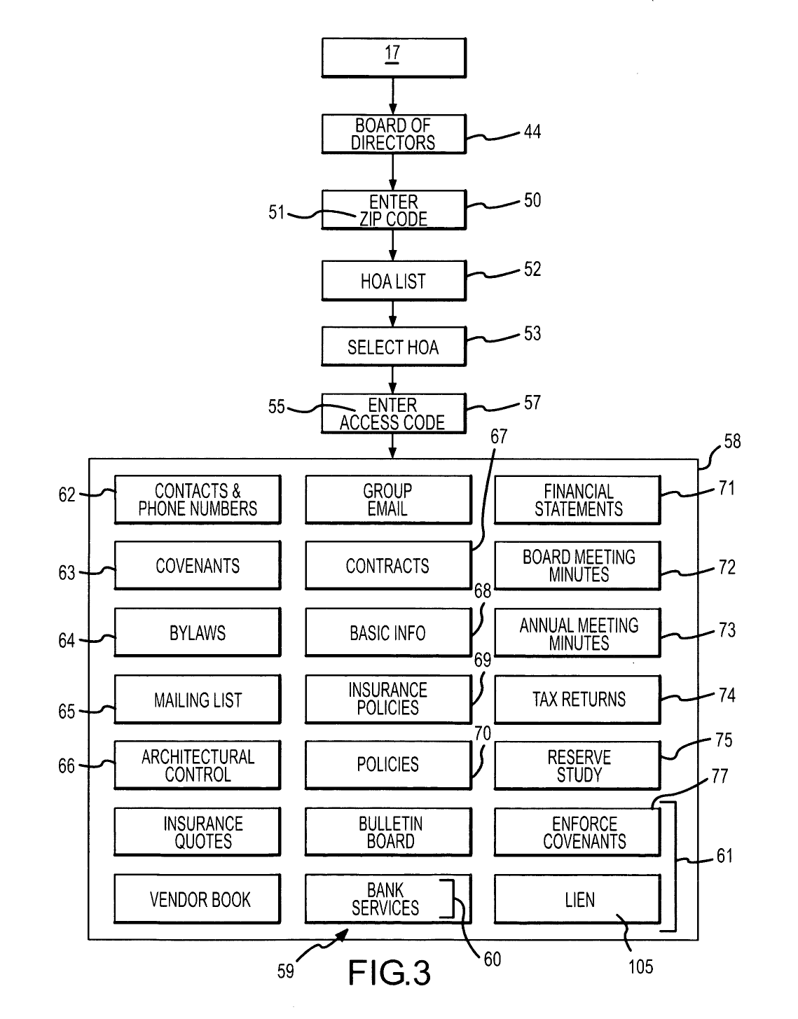

Now referring primarily to FIGS. 1 and 3, the HOA application (17) can further include a homeowners association region access module (49) which functions to allow the computer user to access HOA data (37) matched to the plurality of homeowners association in a within a defined boundary or region, such as country, state, county, city, or the like. One non-limiting embodiment of the homeowners association region access module (49), generates a homeowners association region access field (50) fillable manually (or selectably fillable by click event on one of a plurality of region indicia in a list) with a region indicia (51)(such as a zip code or other region indicia assigned to homeowners associations based). Entry of the region indicia (51) allows the computer user (25) access to the plurality of homeowners associations (38) matched with the selected or entered region indicia, for example, by generation of a list of the plurality of homeowners associations (52) or other grouping which allows selection by click event of one of the plurality of homeowners associations (53) matched to the click event selected or manually entered regional indicia (51).

Again referring primarily to FIGS. 1 and 3, the HOA application (17) can further include a computer user access code module (54) which functions to provide a computer user access field (57) to limit access to HOA data (37) to computer users (25) which have an computer user access code (55) entered into the computer user access field (57) that matches a authorized computer user access code (56) prior entered into the computer user access code module (54). The computer user access field (57) can be utilized to limit access to HOA data (37) matched to each of a plurality of user role identification control icons (40) with viewable role indicia (41)(see for example each of FIGS. 3, 6, 7,8, and 10).

As an example, as to certain embodiments of the HOA application (17), upon click event of one of the plurality of computer user role identification control icons (40)(see FIG. 2) having the viewable role indicia (41) for the Board of Directors (44), and upon selection or entry of the region indicia (51) into the fillable homeowners association region access field (57), the HOA application can generate a board of directors user interface (58) including a plurality of board of directors interface control icons (59) each displaying a viewable board of directors interface control icon identifier (60) which identifies the category of HOA data (37) or one of a plurality of board of directors schema modules (61)(described in detail below) matched to and accessible by click event of the corresponding one of the board of directors interface control icons (59) for a particular one of the plurality of homeowners associations (38) bounded by the entered region identifier (51), and as to the particular embodiment of the board of directors interface (58) shown in FIG. 3, the a viewable board of directors interface control icon identifiers (60) can include: contacts & phone numbers (62), covenants (63), bylaws (64), mailing list (65), architectural control (66), contracts (67), basic information (68), insurance policies (69), homeowner association policies (70), financial statements (71), board meeting minutes (72), annual meeting minutes (73), tax returns (74), homeowner association studies (75), or the like. Click event of any one of the plurality of board of directors interface control icons (59) provides access to the matched HOA data (37) which can be as individual documents or as lists of documents or lists of data entities, each document or data entity displayable by click event.

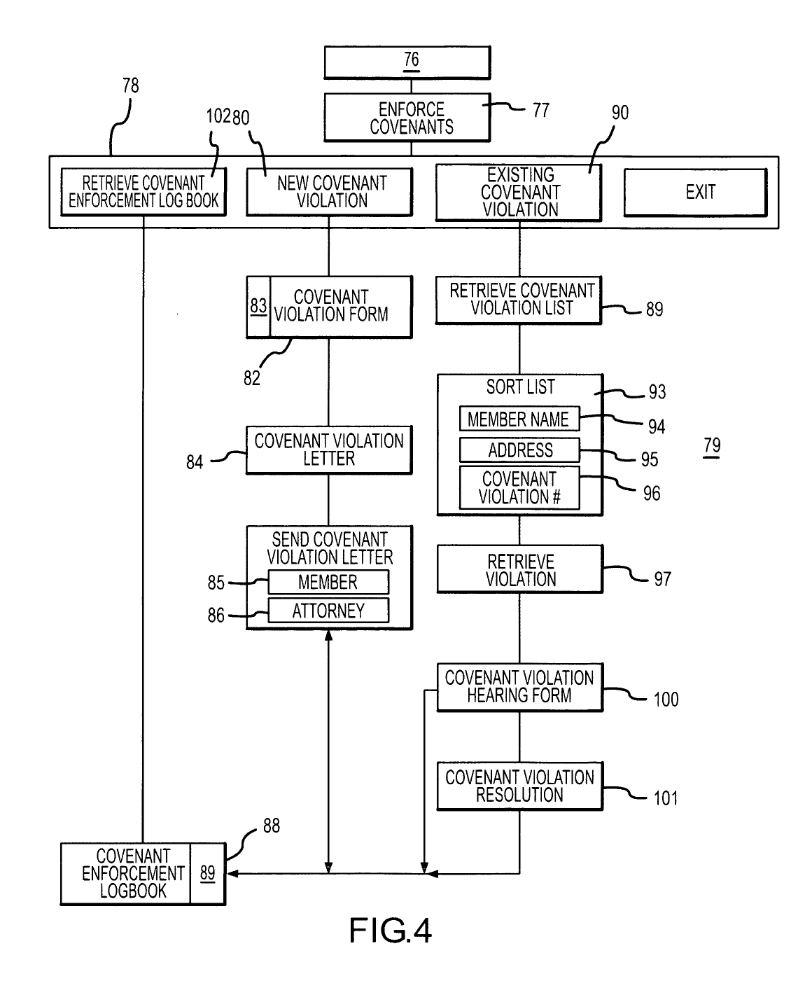

Now referring primarily to FIGS. 1 and 4, the HOA application (17) can further include as one of the plurality of board of directors schema modules (61) an enforce covenants module (76). The enforce covenants module (76) upon activation by click event of the corresponding enforce covenants icon (77) on the board of directors user interface (58) provides an enforce covenants user interface (78) and a homeowners association covenant enforcement schema (79) by which a member of a board of directors (or other authorized computer user (25) of a homeowners association governing body) of one of the plurality of homeowners associations (38) can provide notice to a property owner of one or more of: a perceived covenant violation, a covenant violation, a covenant violation hearing, a covenant resolution. The enforce covenants module (76) further functions to maintain and update a covenant enforcement logbook (88).

In the enforce covenants user interface (78), a new violation icon (80) can by click event activate a covenant violation form generator (81) which functions to display at least one covenant violation form (82)(which as to certain embodiments of the invention can provide a selectable list of covenant violation forms, such as a perceived covenant violation form and a covenant violation form) which can provide a plurality of fillable covenant violation form fields (83) which can be filled to produce a covenant violation letter (84) which can be forwarded by e-mail or printed and forwarded in hardcopy to the homeowner association member (85)(property owner or homeowner) of the one of the plurality of homeowners association (38) or the homeowners association member's attorney (86). An enforcement violation update module (87) functions to update a covenant enforcement logbook (88) and a list of existing covenant violations (89) upon click event which generates the completed covenant violation letter (84).

Similarly, in the enforce covenants user interface (78), an existing violation icon (90) can by click event can activate an existing covenants violation list generator (91) which functions to generate the list of covenant violations (89) and a existing covenant violations sorter (92) which functions by click event to generate a sorted list of existing covenant violations (93) whether by homeowner association member name (94), property address (95), covenant violation number (96), or the like. By click event, one of the existing covenant violations (97) in the sorted list of existing covenant violations (93) can be retrieved and a covenant violation hearing form generator (98) and a covenant violation resolution form generator (99) by click event can generate a completed covenant violation hearing notice (100) or a completed covenant violation resolution notice (101) which can be forwarded by e-mail or printed and forwarded in hardcopy to the homeowner association member (85) of the one of the plurality of homeowners association (38) or the homeowners association member's attorney (86). Upon completion of the either of the covenant hearing form (100) or the covenant violation resolution form (101), the covenant enforcement violation update module (87) can function to update the covenant enforcement log (88) and the list of existing covenant violations (89).

Similarly, in the enforce covenants user interface (78), a covenant enforcement logbook icon (102) can by click event activate a covenant logbook generator module (103) which generates the covenant enforcement logbook (88) for one of the plurality of homeowner associations (38) which provides the list of all existing covenant violations (89) of a homeowner association member (property owner or homeowners). For example in column and row format including as to certain embodiments of the invention: covenant violation number, homeowner association member name, home address, city, state, zip code, covenant violation description, date of perceived violation, date of violation letter, date of attorney letter, date of hearing letter, date of resolution letter, comments. However, it is not intended that this particular example limit the list of all existing covenant violations (89) to a column and row format and other formats can be utilized and updated by the covenant logbook generator module (103) and the covenant violation update module (87).

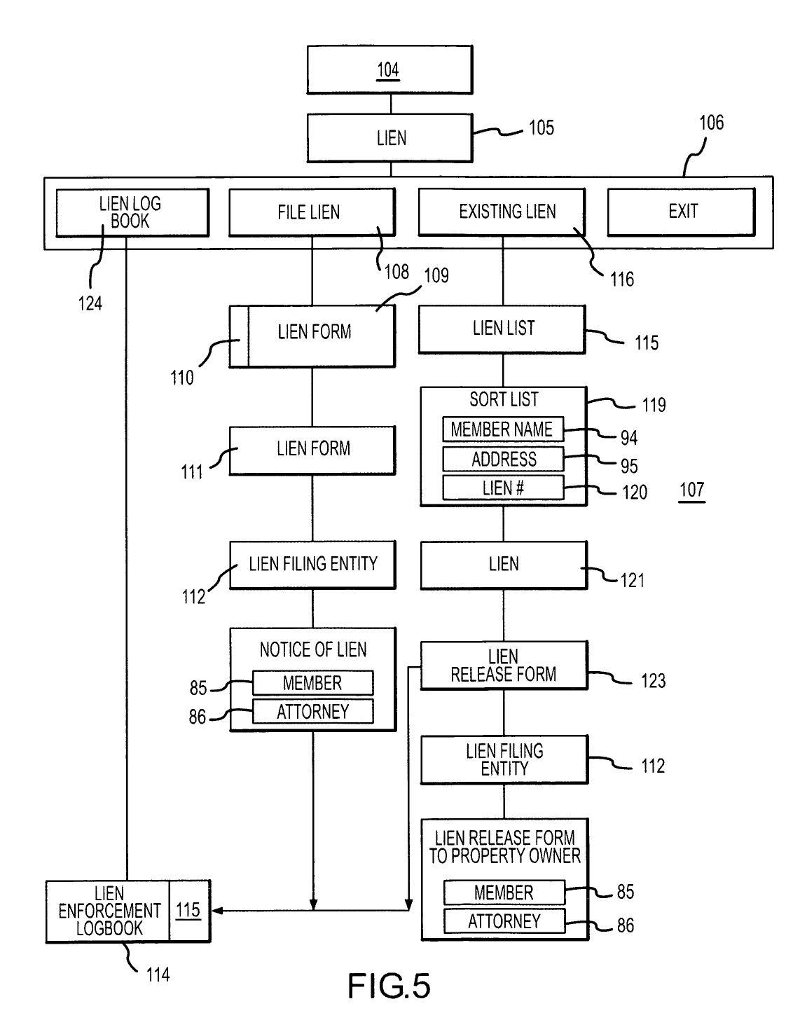

Now referring primarily to FIGS. 1 and 5, the HOA application (17) can further include as one of the plurality of board of directors schema modules (61) a lien module (104). The lien module (104) upon activation by click event of a lien icon (105) on the board of directors user interface (58) provides an lien user interface (106) and a lien enforcement schema (107) by which a member of a board of directors (an computer user (25) having an authorized computer access code) of one of the plurality of homeowners associations (38) can provide notice to a homeowners association member (85) (property owner or homeowner) or the homeowners association member's attorney (86) of one or more of: a lien, a lien release, or the like.

In the lien user interface (106), a file lien icon (108) can by click event activate a lien form generator (108A) which functions to display at least one lien form (109) (or as to certain embodiments of the invention can provide a selectable list of lien forms) which can include a plurality of fillable lien form fields (110) which can be filled to produce a lien form (11) which can be forwarded by e-mail or printed and filed with the appropriate government entity or lien filing entity (112) and also forwarded to the corresponding homeowner association member (85) of one of the plurality of homeowners association (38) or the homeowner association member's attorney (86). A lien update module (113) functions to update a lien enforcement logbook (114) and a list of existing liens (115) upon creation of the lien form (111).

Similarly, in the lien user interface (106), an existing lien icon (116) can by click event activate an existing lien list generator (117) which functions to generate the list of existing liens (115) and a existing liens sorter (118) which functions by click event to generate a sorted list of existing liens (119) whether by homeowner association member name (94), property address (95), lien number (120), or the like. By click event, one of the existing liens (121) in the sorted list of existing liens (119) can be retrieved and a lien release form generator (122) can by click event can generate a completed lien release form (123) which can be forwarded by e-mail or printed and forwarded in hardcopy and filed with the appropriate government entity (112) and also forwarded to the homeowner association member (85) of the one of the plurality of homeowners association (38) or the homeowner association member attorney (86). Upon completion of lien release form (123) the lien update module (113) can function to update a lien enforcement logbook (114) and the list of existing liens (115) upon creation of the lien release form (123).

Similarly, in the lien user interface (106), a lien enforcement logbook icon (124) can by click event activate a lien logbook generator module (125) which generates the lien enforcement logbook (114) for one of the plurality of homeowner associations (38) which can provide the list of existing liens for example in column and row format including as to certain embodiments of the invention: lien number, homeowner association member name, property address, city, state, zipcode, lien description, date lien filed, date lien form to member, date of lien form to attorney, lien release date, comments, or the like.

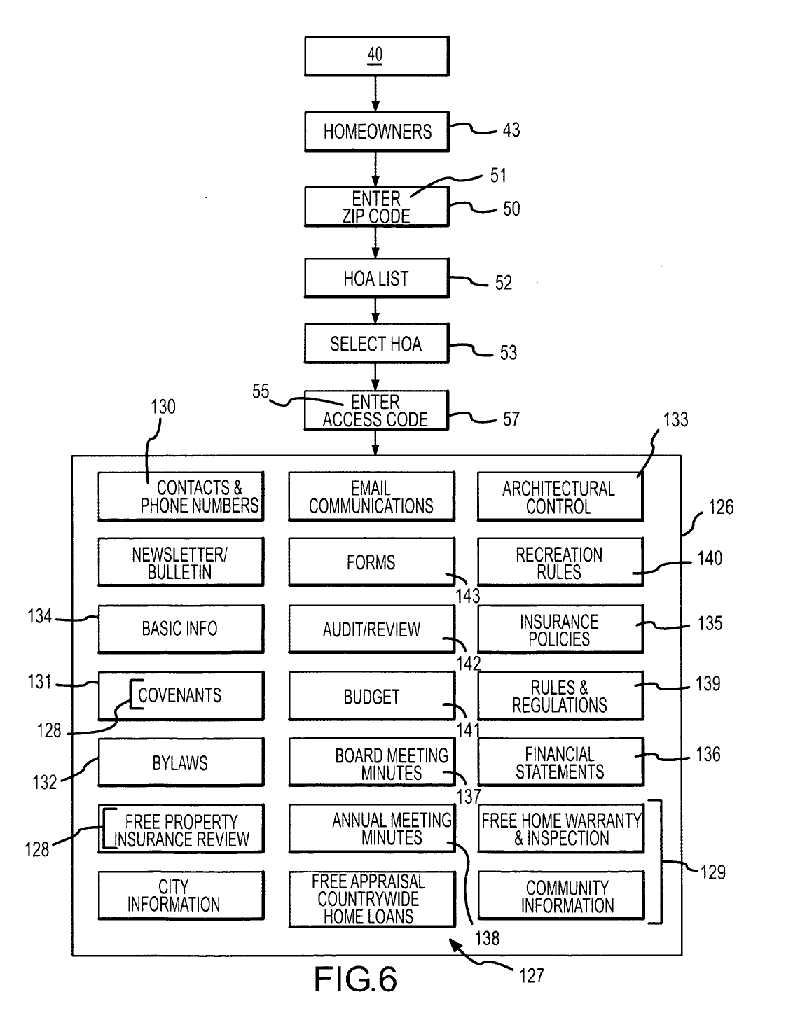

Now referring primarily to FIGS. 1, 2 and 6, as to certain embodiments of the HOA application (17), upon click event of one of the plurality of computer user role identification control icons (40)(see FIG. 2) having the viewable role indicia (41) for Homeowners (43) (homeowner association members or property owners) and selection or entry of the region indicia (51) into the fillable homeowners association region access field (50) the HOA application (17) can generate a homeowners user interface (126) (or property owner graphic user interface) including a plurality of homeowner interface icons (127) each displaying a viewable homeowner interface identifier (128) which identifies a portion of HOA data (37) or a homeowner schema module (129) matched to and accessible by click event of the corresponding one of the homeowner interface icons (127) for a particular one of the plurality of homeowners associations (38) bounded by the entered region identifier (51). As to the particular embodiment of the homeowner user interface (58) shown in FIG. 6, the a viewable homeowner interface identifiers (128) can include: contacts & phone numbers (130), covenants (131), bylaws (132), architectural control (133), basic information (134), insurance policies (135), financial statements (136), board meeting minutes (137), annual meeting minutes (138), homeowners association rules and regulations (139), homeowners association recreation rules (140), homeowners association budget (141), homeowners association audit/review (142), a form file (143), or other homeowner identification identifiers useful to a homeowner such as city information, community information and certain services such as appraisers, home inspectors, or the like. Click event of any one of the plurality of homeowners interface control icons (127) provides access to the matched HOA data (37) which can be displayed as individual documents or as lists of documents or lists of data entities, each document or data entity listed further displayable by click event.

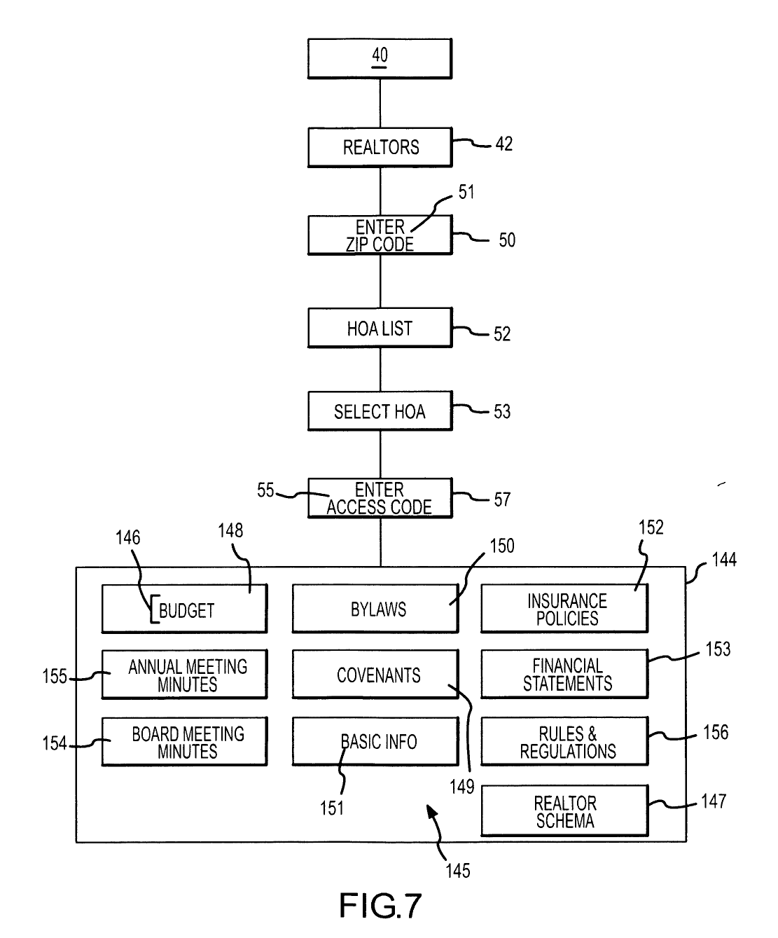

Now referring primarily to FIGS. 1, 2 and 7, as to certain embodiments of the HOA application (17), upon click event of one of the plurality of computer user role identification control icons (40)(see FIG. 2) having the viewable role indicia (41) for Realtors (42) and selection or entry of the region indicia (51) into the fillable homeowners association region access field (50) the HOA application (17) can generate a realtor user interface (144) including a plurality of realtor interface icons (145) each displaying a viewable realtor interface identifier (146) which identifies the category of HOA data (37) or a realtor schema modules (147) matched to and accessible by click event of the corresponding one of the realtor interface icons (145) for a particular one of the plurality of homeowners associations (38) bounded by the entered region identifier (51), and as to the particular embodiment of the homeowner user interface (145) shown in FIG. 7, the a viewable realtor interface identifier (127) can include: homeowners association budget (148), covenants (149), bylaws (150), basic information (151), insurance policies (152), financial statements (153), board meeting minutes (154), annual meeting minutes (155), homeowners association rules and regulations (156) or other information useful to a Realtor in performing activities in relation to the particular one of the plurality of homeowners associations. Click event of any one of the plurality of realtor interface control icons (145) provides access to the matched HOA data (37) which can be displayed as individual documents or as lists of documents or lists of data entities, each document or data entity listed further displayable by click event.

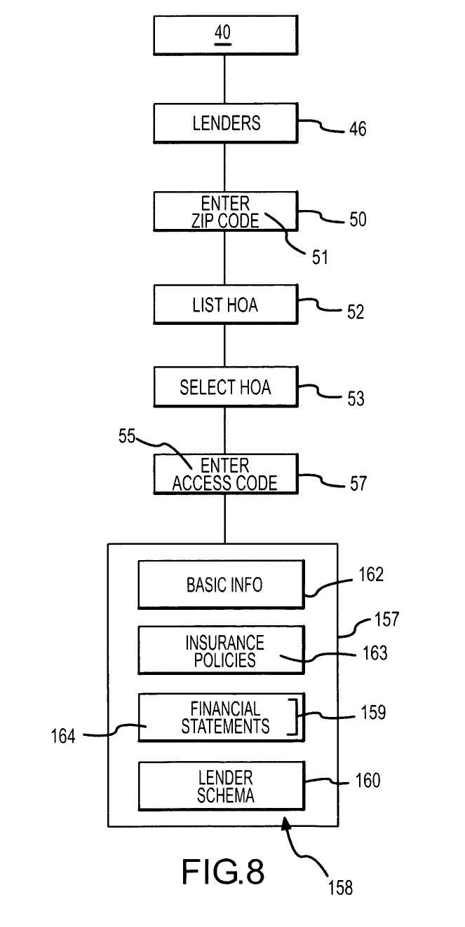

Now referring primarily to FIGS. 1, 2 and 8, as to certain embodiments of the HOA application (17), upon click event of one of the plurality of computer user role identification control icons (40)(see FIG. 2) having the viewable role indicia (41) for Lenders (42) and selection or entry of the region indicia (51) into the fillable homeowners association region access field (50) the HOA application (17) can generate a lender user interface (157) including a plurality of lender interface icons (158) each displaying a viewable lender interface identifier (159) which identifies the category of HOA data (37) or a viewable lender schema identifier (160) which identifies one of a plurality of realtor schema modules (161) matched to and accessible by click event of the corresponding one of the lender interface icons (158) for a particular one of the plurality of homeowners associations (38) bounded by the entered region identifier (51), and as to the particular embodiment of the lender user interface (157) shown in FIG. 8, the a viewable lender interface identifiers (158) can include: basic information (162), insurance policies (163), financial statements (164) or other lender user interface icons matched to information useful to a Lender in performing activities in relation to the particular one of the plurality of homeowners associations. Click event of any one of the plurality of lender interface control icons (158) provides access to the matched HOA data (37) which can be displayed as individual documents or as lists of documents or lists of data entities, each document or data entity listed further displayable by click event.

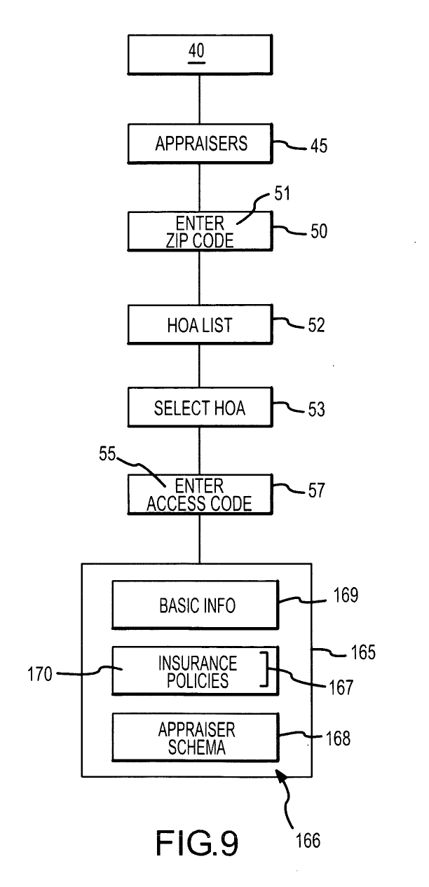

Now referring primarily to FIGS. 1, 2 and 9, as to certain embodiments of the HOA application (17), upon click event of one of the plurality of computer user role identification control icons (40)(see FIG. 2) having the viewable role indicia (41) for Appraisers (45) and selection or entry of the region indicia (51) into the fillable homeowners association region access field (57) the HOA application (17) can generate a appraiser user interface (165) including a plurality of appraiser interface icons (166) each displaying a viewable appraiser interface identifier (167) which identifies the category of HOA data (37) or a viewable appraiser identifier (167) which identifies one of a plurality of appraiser schema modules (168) matched to and accessible by click event of the corresponding one of the appraiser interface icons (166) for a particular one of the plurality of homeowners associations (38) bounded by the entered region identifier (51), and as to the particular embodiment of the lender user interface (157) shown in FIG. 9, the a viewable appraiser interface identifiers (166) can include: basic information (169), insurance policies (170), or other appraiser user interface icons matched to information useful to an Appraiser in performing activities in relation to the particular one of the plurality of homeowners associations. Click event of any one of the plurality of appraiser interface control icons (166) provides access to the matched HOA data (37) which can be displayed as individual documents or as lists of documents or lists of data entities, each document or data entity listed further displayable by click event.

Now referring primarily to FIGS. 1, 2 and 10, as to certain embodiments of the HOA application (17), upon click event of one of the plurality of computer user role identification control icons (40)(see FIG. 2) having the viewable role indicia (41) for Status Letter (47) the HOA application (17) can further activate the access code module (54) which can generate a title company user access interface (171) having at least a title company user access field (172) fillable with a title company access code (173) which allows access to HOA data (37) to computer users (25) which have an title company access code (173) that matches a pre-authorized access code (56) prior entered into the user access code module (54). The user access code module (54) can further generate a homeowners association managers access field (174) fillable with a homeowners association managers access code (175) which then functions to allow access to HOA data (37) to computer users (25) which have an homeowners managers access code (173) that matches a pre-authorized access code (56) prior entered into the user access code module (52).

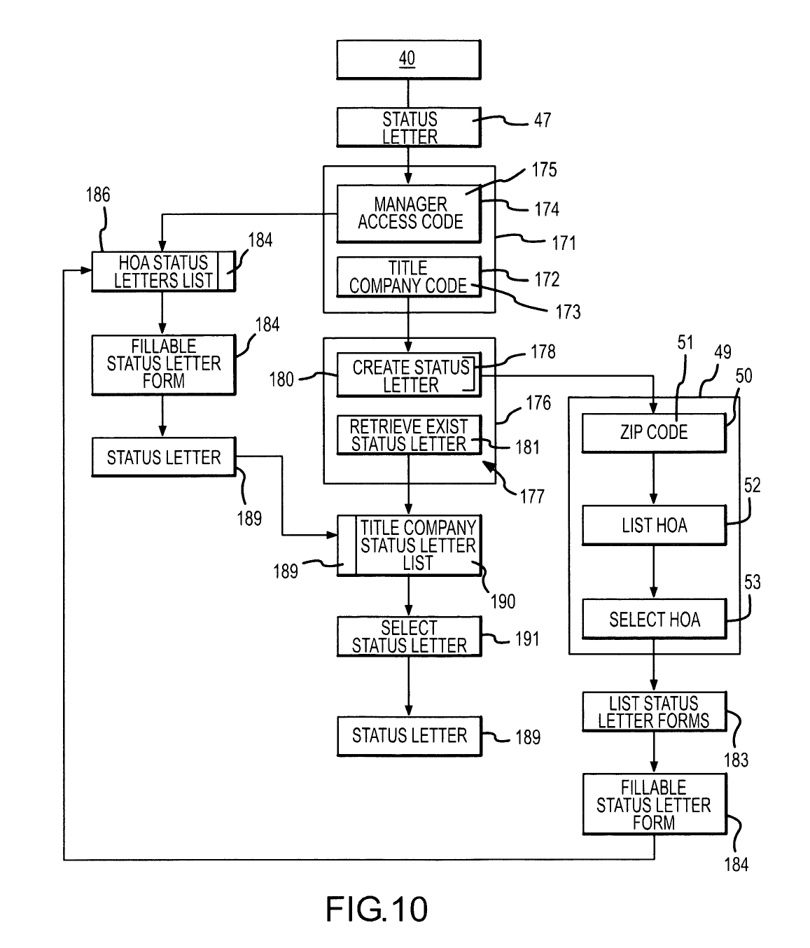

Entering a title company access code (173) which matches a pre-authorized title company access code (56) the HOA application (17) can generate a title company user interface (176) which includes a plurality of title company interface icons (177) each displaying a viewable title company interface identifier (178) which identifies the category of HOA data (37) or which identifies one of a plurality of title company schema modules (179) matched to and accessible by click event of the corresponding one of the title company interface icons (177). As to the particular embodiment of the title company user interface (176) shown in FIG. 10, the a viewable title company interface identifiers (178) of title company interface icons (177) include: create a status letter (180) and retrieve a status letter (181), and can further include other title company user interface icons matched to information useful to a title company in performing activities in relation to the particular one of the plurality of homeowners associations.

Selection by click event of the one of the title company icons (177) having the title company interface identifier (180) Create A Status Letter further activates an embodiment of the homeowners association region access module (49) which functions to allow the computer user (25) to have access to a list of fillable status letter forms (183) matched to one of the plurality of homeowners associations (38) in a defined region, such as country, state, county, city, or the like, selected by click event. The non-limiting embodiment of the homeowners association region access module (49) shown in FIG. 10, generates a homeowners association region access field (50) fillable or selectably fillable with a region indicia (51)(such as a zip code or other region indicia assigned to homeowners associations based on a defined boundary). Entry of the region indicia (51) allows the computer user (25) access to the plurality of homeowners associations matched with the selected or entered region indicia, for example, by generation of a list of the plurality of homeowners associations (52)(or other grouping) which by click event allows selection of one of the plurality of homeowners associations (53) matched to the selected or entered regional indicia (51) from the list of the plurality of homeowners associations (52).

Click event of one fillable status letter forms (184) in the list of status letter forms (183) activates a status letter form generator (185) which displays the selected fillable status letter form (184) for the selected one of the plurality of homeowners associations (38). The computer user (25) for the title company enters information into a portion of the fields of the fillable status letter form (184) sufficient to identify a property being sold in the selected one of the plurality of homeowners associations (38)(along with other information depending upon the status letter form generated, such as buyer and seller information). Click event adds the fillable status letter form (184)(as partly filled by the computer user (25) for the title company) to a homeowners association status letters list (186) accessible by the homeowners association manager (or other homeowners association member responsible for preparing status letters) for the selected one of the plurality of the homeowners associations (38).

A homeowners association manager, upon entry of the access code (175) in the homeowners association managers access field (174) activates a homeowners association schema module (187) which allows the homeowners association manager to access to the homeowners association status letters list (186) and by click event selection of one of the fillable status letters (184) in the homeowners association status letters list (186) the selected one of the fillable status letters (184) as partly filled by the computer user (25) of the title company can be retrieved. The homeowners association manager can then enter HOA data (37) into the remaining unfilled status letter fields (either manually or by click event) to complete a status letter (189). Upon completion, the status letter (189) can by click event be added to the title company status letter list (190).

Selection by click event of one of the title company icons (177) having the title company interface identifier (178) Retrieve Existing Status Letters (181) further activates the title company schema module (187) which functions to generate the title company status letter list (190). Selection of one of the plurality of the status letters (189) in the title company status letter list (190) retrieves and displays the status letter (189).

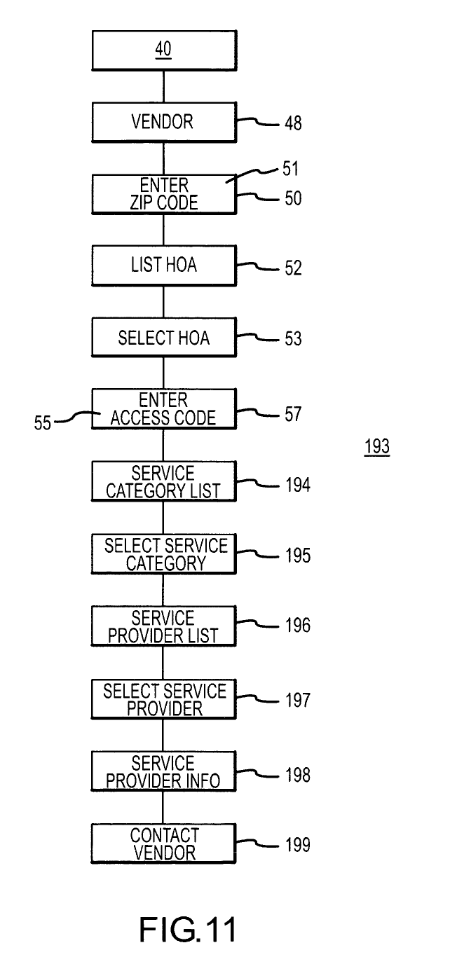

Now referring primarily to FIGS. 1, 2 and 11, as to certain embodiments of the HOA application (17), upon click event of one of the plurality of computer user role identification control icons (40)(see FIG. 2) having the viewable role indicia (41) for Vendor (48) and selection or entry of the region indicia (51) into the fillable homeowners association region access field (50) a vendor schema module (192) of the HOA application (17) can generate a vendor schema (193) which allows a computer user (25) by click event to access a vendor service category list (194) each service category (195) selectable by click event allows access to a service provider list (196) for a particular one of the plurality of homeowners associations (38) bounded by the entered region identifier (51). By click event one of the plurality of service providers (197) can be selected from the service provider list (196) to generate service provider data (198) for the selected one of the service providers (197). As to the particular embodiment of the homeowner user interface (58) shown in FIG. 11, the selected one of the service providers (197) can be contacted by click event of a service provider contact element (199).

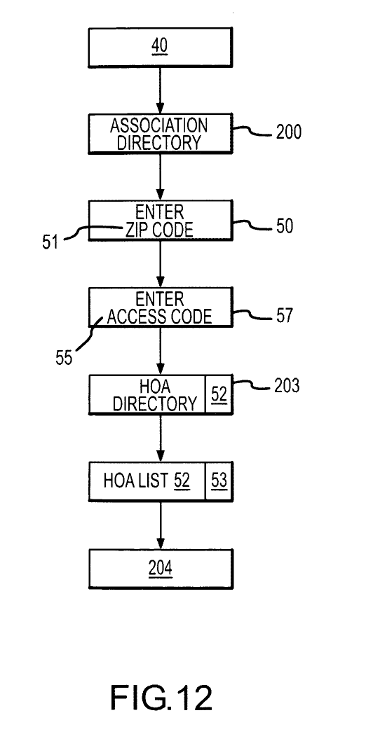

Now referring primarily to FIGS. 1, 2 and 12, as to certain embodiments of the HOA application (17), the an embodiment of the computer user role identification interface (39) can further provide an directory icon (200) having an icon identifier (201) Homeowners Association Directory (201) and selection or entry of the region indicia (51) into the fillable homeowners association region access field (50) a homeowners association directory module (202) of the HOA application (17) can generate a homeowners association directory (203) which allows a computer user (25) by click event to access to the plurality of homeowners associations (38) matched with the selected or entered region indicia, for example, by generation of a list of the plurality of homeowners associations (52) or other grouping which allows selection by click event of one of the plurality of homeowners associations (53) matched to the selected or entered regional indicia (51) to obtain HOA information (204).

As can be easily understood from the foregoing, the basic concepts of the present invention may be embodied in a variety of ways. The invention involves numerous and varied embodiments of a computer implemented system for distributing homeowner association information to a plurality of user computers over a local area network or over a wide area network such as the Internet.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “server” should be understood to encompass disclosure of the act of “serving”—whether explicitly discussed or not—and, conversely, were there effectively disclosure of the act of “serving”, such a disclosure should be understood to encompass disclosure of a “server” and even a “means for serving.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the computer-implemented systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The claims are intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

I claim:

1. A computer-implemented method of providing access to homeowner association data on the Internet, comprising the steps of:
a. storing homeowner association data of a plurality of homeowner associations in a memory element of a server computer;
b. providing a HOA graphic user interface to a plurality of user computers which displays a plurality of user role identification icons each one matched to a portion of said homeowner association data in said memory element of said server computer, wherein said plurality of user role identification icons includes at least a board of directors icon and a homeowners icon; and
c. selecting one of said plurality of user role identification icons to access said portion of said homeowner association data stored in said memory element of said server computer.

2. A computer-implemented method of providing access to homeowner association data on the Internet as described in claim 1, further comprising the step of selecting a first of said plurality of role identification icons which functions to match a member of a board of directors of one of said plurality of homeowner associations to said portion of said homeowner association data which corresponds to said one of said plurality of homeowner associations.

3. A computer-implemented method of providing access to homeowner association data on the Internet as described in claim 2, further comprising the step of accessing said portion of said homeowner association data which corresponds to said one of said plurality of homeowner associations by use of a board of directors graphic user interface which provides a plurality of board member interface icons each of which activates one of a plurality of board member modules from the group consisting of: an enforce covenants module, a lien module, a bank services module, a vendor module, an insurance quotes module.

4. A computer-implemented method of providing access to homeowner association data on the Internet as described in claim 3, further comprising the step of accessing said enforce covenants module which further provides selectable access to a covenants logbook generator module which operates to display a list of existing covenant violations by a property owner of said one of said plurality of homeowner associations.

5. A computer-implemented method of providing access to homeowner association data on the Internet as described in claim 4, further comprising the steps of accessing said enforce covenants module which further provides selectable access to a new covenants violation module which operates to generate a list of fillable covenant violation forms, wherein at least one of said fillable covenant violation forms has a plurality of fillable covenant violation form fields which can be filled to produce a covenant violation letter.

6. A computer-implemented method of providing access to homeowner association data on the Internet as described in claim 5, further comprising the step of updating said list of existing covenant violations upon sending said covenant violation letter to said homeowner of said one of said plurality of homeowner associations.

7. A computer-implemented method of providing access to homeowner association data on the Internet as described in claim 6, further comprising the step of accessing said enforce covenants module which further operates to generate a list of covenant violations sortable by each said property owner of said one of said plurality of homeowner associations.

8. A computer-implemented method of providing access to homeowner association data on the Internet as described in claim 7, further comprising the steps of retrieving an existing covenant violation from said list of covenant violations which further provides selectable access to a fillable covenant violation form fillable to produce a covenant violation hearing notice.

9. A computer-implemented method of providing access to homeowner association data on the Internet as described in claim 7, further comprising the steps of retrieving an existing covenant violation from said list of covenant violations which further provides selectable access to a fillable covenant violation resolution form fillable to produce a covenant violation resolution notice.

10. A computer-implemented method of providing access to homeowner association data on the Internet as described in claim 8, further comprising the step of updating said list of covenant violations in a covenant enforcement log upon sending said covenant violation hearing notice to said homeowner of said one of said plurality of homeowner associations.

11. A computer-implemented method of providing access to homeowner association data on the Internet as described in claim 9, further comprising the step of updating list of covenant violations in said covenant enforcement log upon sending said covenant violation resolution notice to said homeowner of said one of said plurality of homeowner associations.

12. A computer-implemented method of providing access to homeowner association data on the Internet as described in claim 3, further comprising the step of accessing said lien module which further provides selectable access to a lien enforcement log which provides a list of liens against each said property owner of said one of said plurality of homeowner associations.

13. A computer-implemented method of providing access to homeowner association data on the Internet as described in claim 3, further comprising the step of accessing said lien module which further provides selectable access to a lien form generator which operates to generate a lien form fillable to produce a lien form for filing with a lien filing entity.

14. A computer-implemented method of providing access to homeowner association data on the Internet as described in claim 14, further comprising the step of forwarding said lien form to said property owner of said one of said plurality of homeowner associations.

15. A computer-implemented method of providing access to homeowner association data on the Internet as described in claim 14, further comprising the step of updating said lien enforcement log upon producing said lien form for filing with said lien filing entity.

16. A computer-implemented method of providing access to homeowner association data on the Internet as described in claim 3, further comprising the steps of accessing said lien module which further provides selectable access to a existing lien list generator which operates to generate a list of liens sortable by each said property owner of said one of said plurality of homeowner associations.

17. A computer-implemented method of providing access to homeowner association data on the Internet as described in claim 16, further comprising the steps of retrieving an existing lien from said list of liens which further activates a lien release form generator which operates to generate a lien release form.

18. A computer-implemented method of providing access to homeowner association data on the Internet as described in claim 17, further comprising the step of updating said list of liens in said lien enforcement log upon generating said lien release form.

19. A computer-implemented method of providing access to homeowner association data on the Internet as described in claim 1, further comprising the step of selecting a second of said plurality of icons which functions to match one of a plurality of property owners of one of said plurality of homeowner associations to said portion of said homeowner association data which corresponds to said one of said plurality of property owners.

20. A computer-implemented method of providing access to homeowner association data on the Internet as described in claim 19, further comprising the step of accessing said portion of said homeowner association data which corresponds to said one of said plurality of property owners by use of a property owner graphic user interface which provides a plurality of homeowner icons each of which activates one of a plurality of homeowner modules.

21. A computer-implemented method of providing access to homeowner association data on the Internet as described in claim 1, wherein said step of providing a graphic user interface to a plurality of user computers which displays a plurality of icons each one matched to a portion of said homeowner association data in said memory element of said server computer further comprises the step of providing a realtor icon matched to a portion of said homeowners association data.

22. A computer-implemented method of providing access to homeowner association data on the Internet as described in claim 21, further comprising the step of accessing said portion of said homeowner association data by use of a realtor graphic user interface which provides a plurality of realtor icons each of which activates one of a plurality of realtor modules.

23. A computer-implemented method of providing access to homeowner association data on the Internet as described in claim 1, wherein said step of providing a graphic user interface to a plurality of user computers which displays a plurality of icons each one matched to a portion of said homeowner association data in said memory element of said server computer further comprises the step of providing a lender icon matched to a portion of said homeowners association data.

24. A computer-implemented method of providing access to homeowner association data on the Internet as described in claim 23, further comprising the step of accessing said portion of said homeowner association data by use of a lender graphic user interface which provides a plurality of lender icons each of which activates one of a plurality of lender modules.

25. A computer-implemented method of providing access to homeowner association data on the Internet as described in claim 1, wherein said step of providing a graphic user interface to a plurality of user computers which displays a plurality of icons each one matched to a portion of said homeowner association data in said memory element of said server computer further comprises the step of providing an appraiser icon matched to a portion of said homeowners association data.

26. A computer-implemented method of providing access to homeowner association data on the Internet as described in claim 25, further comprising the step of accessing said portion of said homeowner association data by use of a graphic user interface which provides a plurality of appraiser icons each of which activates one of a plurality of appraiser modules.

27. A computer-implemented method of providing access to homeowner association data on the Internet as described in claim 1, wherein said step of providing a graphic user interface to a plurality of user computers which displays a plurality of icons each one matched to a portion of said homeowner association data in said memory element of said server computer further comprises the step of providing a status letter icon matched to a portion of said homeowners association data accessible by a title company.

28. A computer-implemented method of providing access to homeowner association data on the Internet as described in claim 27, further comprising the step of generating a list of fillable status letters corresponding to a selected one of said plurality of homeowner associations.

29. A computer-implemented method of providing access to homeowner association data on the Internet as described in claim 28, further comprising the step of filling a portion of said status letter by said title company to identify a property in said selected one of said plurality of homeowner associations.

30. A computer-implemented method of providing access to homeowner association data on the Internet as described in claim 29, further comprising the step of updating a list of status letters corresponding to one of said plurality of homeowners association with said status letter having a portion filled by said title company.

31. A computer-implemented method of providing access to homeowner association data on the Internet as described in claim 30, wherein said step of providing a graphic user interface to a plurality of user computers which displays a plurality of icons each one matched to a portion of said homeowner association data in said memory element of said server computer further comprises the step of providing a status letter icon matched to a portion of said homeowners association data accessible by a manager of one of said plurality of homeowners associations.

32. A computer-implemented method of providing access to homeowner association data on the Internet as described in claim 31, further comprising the step of accessing said list of status letters corresponding to one of said plurality of homeowners association with said status letter having said portion filled by said title company.

33. A computer-implemented method of providing access to homeowner association data on the Internet as described in claim 32, further comprising the step of filling the remaining portion of said status letter by said manager of one of said plurality of homeowners associations.

34. A computer-implemented method of providing access to homeowner association data on the Internet as described in claim 33, further comprising the steps of generating a filled status letter and sending said filled status letter to said title company.

35. A computer-implemented method of providing access to homeowner association data on the Internet as described in claim 1, wherein said step of providing a graphic user interface to a plurality of user computers which displays a plurality of icons each one matched to a portion of said homeowner association data in said memory element of said server computer further comprises the step of providing a vendor icon matched to a portion of said homeowners association data.

36. A computer-implemented method of providing access to homeowner association data on the Internet as described in claim 35, further comprising the step of selectably accessing a vendor module which operates to generate a list of vendors corresponding to one of said plurality of homeowner associations.

37. A computer-implemented method of providing access to homeowner association data on the Internet as described in claim 1, wherein said step of providing a graphic user interface to a plurality of user computers which displays a plurality of icons each one matched to a portion of said homeowner association data in said memory element of said server computer further comprises the step of providing a homeowner association directory icon matched to a portion of said homeowners association data.

38. A computer-implemented method of providing access to homeowner association data on the Internet as described in claim 37, further comprising the step of selectably accessing a homeowner association directory sortable by a plurality of zipcodes which operates to generate a list of homeowner associations corresponding to one of said plurality of zipcodes.
